(19) United States
(12) Patent Application Publication
(10) Pub. No.: US 2022/0166108 A1
(43) Pub. Date: May 26, 2022

(54) SEPARATOR FOR SECONDARY BATTERIES AND SECONDARY BATTERIES INCLUDING THE SAME

(71) Applicant: Naieel Technology Inc., Daejeon (KR)

(72) Inventors: Jaewoo KIM, Daejeon (KR); Jung Hwan JUNG, Daejeon (KR); Ki In CHOI, Daejeon (KR)

(21) Appl. No.: 17/535,447

(22) Filed: Nov. 24, 2021

(30) Foreign Application Priority Data
Nov. 25, 2020 (KR) 10-2020-0160549

(51) Int. Cl. H01M 50/446; H01M 50/403

(52) U.S. Cl. CPC H01M 50/446; H01M 50/403

(57) ABSTRACT

The present disclosure provides a separator for a secondary battery which is formed of a porous sheet which includes a binder polymer and boron nitride nanotubes to show excellent electrical insulation, thermal stability, mechanical strength, and reduced weight and contribute to compactness of the secondary battery

### CROSS-REFERENCE TO RELATED APPLICATION (S)

This application claims the priority of Korean Patent Application No. 10-2020-0160549 filed on Nov. 25, 2020, in the Korean Intellectual Property Office (KIPO), the disclosure of which is incorporated herein by reference.

### BACKGROUND

### 1. Field

The present disclosure generally relates to a separator for a secondary battery and a secondary battery including the same, and more particularly, to a separator for a secondary battery which includes polymer and boron nitride nanotubes as components to reduce a weight while improving physical properties such as electrical insulation, thermal stability, and mechanical strength and a compact secondary battery including the same.

### 2. Description of the Related Art

Recently, interest in the energy storage technology is growing rapidly. An application field expands to energy sources of mobile phones, and camcorders, and notebook computers as well as the electric vehicles so that the development of rechargeable secondary batteries, specifically, lithium secondary batteries has become the focus of attention.

A separator used for such secondary batteries is required to maintain a chemical stability and prevent deterioration at an interface of an electrolyte and an electrode in a battery charging/discharging region while maintaining an excellent electrical insulation and have a porosity and a pore size enough to smoothly ensure movement of lithium ions in the electrolyte.

Further, the separator for a secondary battery needs to have a thermal stability. When the separator for a secondary battery passes a softening temperature of the separator for a secondary battery due to temperature rise in the battery, the separator for a secondary battery shrinks so that it is desirable that less thermal shrinkage occurs at a high temperature.

Further, the separator for a secondary battery needs to have a good wettability and have continuous electrolyte content. The wettability is important to improve productivity during an electrolyte injecting process and the continuous electrolyte content affects the lifespan of the battery.

Moreover, there is a demand for studies to improve the electrical characteristics of the secondary batteries by the self-configuration of the separator for a secondary battery.

### SUMMARY

An object of the present disclosure is to provide a separator for a secondary battery having both an excellent electrical insulation and thermal stability.

Further, the inventors intend to provide a separator for a secondary battery which contributes to weight reduction and compactness of the secondary battery with excellent electrical insulation and thermal stability.

Further, the inventors intend to provide a secondary battery including a separator for a secondary battery according to the present disclosure with advantageous such as improved high temperature stability, reduced weight, and compactness.

A first embodiment of the present disclosure provides a separator for a secondary battery, which is formed of a single layer of porous sheet, in which the porous sheet includes a polymer matrix; and boron nitride nanotubes which are embedded in the matrix.

According to a second embodiment of the present disclosure, in the first embodiment, the boron nitride nanotubes may form a network in the polymer.

A third embodiment of the present disclosure provides a separator for a secondary battery which is formed of a single layer of porous sheet, in which the porous sheet is a non-woven fiber web, and the non-woven fiber web includes a polymer fiber and boron nitride nanotubes which are embedded in the fiber.

According to a fourth embodiment of the present disclosure, in the third embodiment, the boron nitride nanotubes may be embedded in the fiber in a fiber length direction.

According to a fifth embodiment of the present disclosure, in any one of the first to fourth embodiments, the polymer may be selected from the group including polyvinylidene fluoride (PVdF), polyvinylidene fluoride-co-hexafluoropropylene (PVdF-HFP), polyvinylidene fluoride-co-trichloroethylene, polymethylmethacrylate, polyacrylonitrile, polyvinylpyrrolidone, polyvinylacetate, polyethylene-co-vinyl acetate, cellulose acetate, cellulose acetate butyrate, cellulose acetate propionate, cyanoethylpullulan, cyanoethylpolyvinylalcohol, cyanoethylcellulose, cyanoethylsucrose, pullulan, carboxyl methyl cellulose, acrylonitrile-styrenebutadiene copolymer, polyimide, styrene butadiene rubber (SBR), carboxymethylcellulose, polyethylene oxide, polyepichlorohydrin, polyphosphazene, polyvinylpyridine, chlorosulfonated polyethylene, latex, polyester resin, acrylic resin, epoxy resin, polyvinyl alcohol, hydroxypropyl cellulose, and polyolefin.

According to a sixth embodiment of the present disclosure, in any one of the first to fifth embodiments, the polymer may be polyvinylidene fluoride or polyvinylidene fluoride-co-hexafluoropropylene.

According to a seventh embodiment of the present disclosure, in any one of the first to sixth embodiments, the porous sheet may include 2 to 90 parts by weight of boron nitride nanotubes based on 100 parts by weight of polymer.

According to an eighth embodiment of the present disclosure, in any one of the first to seventh embodiments, the boron nitride nanotubes may have an average external diameter in the range of 10 nm to 100 nm, an average length of 1 μm to 50 μm, and an aspect ratio in the range of 10 to 5000.

According to a ninth embodiment of the present disclosure, in any one of the first to eighth embodiments, the boron nitride nanotubes may have a bulk density in the range of 2.0 g/cm³ to 2.2 g/cm³.

According to a tenth embodiment of the present disclosure, in any one of the first to ninth embodiments, the separator for a secondary battery may have a thermal shrinkage in the range of 0 to 10% after thermal treatment at 170° C. for 30 minutes and a thermal shrinkage in the range of 0 to 20% or 0 to 10% after thermal treatment at 200° C. for 30 minutes.

According to an eleventh embodiment of the present disclosure, in any one of the first to tenth embodiments, the separator for a secondary battery may have a density in the range of 0.3 g/cm³ to 0.7 g/cm³.

A twelfth embodiment of the present disclosure provides a secondary battery including an anode, a cathode, and a separator interposed between the anode and the cathode, and the separator is a separator disclosed in any one of first to eleventh embodiments.

The separator for a secondary battery of the present disclosure includes the polymer and the boron nitride nanotubes as main components to simultaneously show excellent electrical insulation and thermal stability.

Further, the separator for a secondary battery of the present disclosure has a small amount of boron nitride nanotubes having a hollow structure so that a weight is lighter than that of a separator of the related art having a structure in which a ceramic layer is further formed on one surface or both surfaces of a porous base material by ceramic particles (inorganic particles), which enables lightweight of the secondary battery. Further, since the boron nitride nanotubes form a network in the polymer, the separation from the separator does not occur even after a long-time use, which contributes to long-term stability of the separator.

Further, the separator for a secondary battery of the present disclosure has a single layer structure in which the boron nitride nanotubes are dispersed in the polymer separator to form a network so that as compared with the separator of the related art having a structure in which the ceramic layer is further formed on one surface or both surfaces of the porous base material, the separation of the boron nitride nanotubes are suppressed and thinner thickness is provided, which improves the stability of the secondary battery and allows the compactness.

In addition, for the separator of the related art, an additional process for coating the inorganic nano particles on a surface of the separator using a polymer binder is essential. However, the separator for a secondary battery of the present disclosure does not require the additional process and the polymer and the boron nitride nanotubes are combined by one process so that a separate process of coating an inorganic material is not necessary, which contributes to simplification and the economic feasibility of the manufacturing process of the secondary battery and compactness of the secondary battery.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a scanning electron microscope (SEM) photograph of a separator for a secondary battery using electro spinning of Example 1-1;

FIG. 2 is a transmission electron microscope (TEM) photograph of a polymer fiber which configures a separator for a secondary battery using electro spinning of Example 1-1 in which boron nitride nanotubes are present in the same direction;

FIGS. 3A and 3B are SEM photographs with resolution magnification of 1,000 times and 10,000 times of a separator for a secondary battery using bar-coating of Example 2-1;

FIG. 4 is a view of a configuration of a coin-cell secondary battery evaluated using separators prepared in Example and Comparative Example;

FIG. 5A is an SEM photograph of a separator for a secondary battery using neat PVDF electro spinning of Comparative Example 1-1;

FIG. 5B is a TEM photograph of a neat PVDF fiber;

FIG. 5C is an SEM photograph of a neat PVDF separator manufactured by bar-coating of Comparative Example 2-1;

FIG. 5D is an SEM photograph of a plan view of a separator coated with an inorganic alumina nano particle of Comparative Example 3-1;

FIG. 5E is an SEM photograph of a fracture of a separator coated with an inorganic alumina nano particle of Comparative Example 3-1;

FIG. 6A is a photograph showing thermal shrinkages of separators at 170° C. and 200° C. of Comparative Example 1-1, Example 1-1, Comparative Example 2-1, and Example 2-1;

FIG. 6B is a photograph showing a thermal shrinkage of a separator of Comparative Example 3-1;

FIGS. 7A and 7B are graphs obtained by measuring a tensile strength when a separator for a secondary battery of Comparative Example and Example is ruptured; and

FIGS. 8A and 8B are charging/discharging graphs of a secondary battery of Examples 1-2 and 2-2.

### DETAILED DESCRIPTION OF THE PREFERRED EMBODIMENT

Hereinafter, embodiments of the present disclosure will be described in more detail. However, the embodiments are provided only for illustrative purposes, but do not limit the present disclosure and the present disclosure is defined only by the scope of the claims to be described below.

Unless otherwise defined, all terms (including technical and scientific terms) used in the present specification may be used as the meaning which may be commonly understood by the person with ordinary skill in the art, to which the present invention belongs.

Throughout the specification of the present disclosure, unless explicitly described to the contrary, the word “comprise” and variations such as “comprises” or “comprising”, will be understood to imply the inclusion of stated elements but not the exclusion of any other elements. Unless particularly stated otherwise in the present specification, a singular form also includes a plural form.

Hereinafter, preferred exemplary embodiments of the present invention will be described in detail with reference to the accompanying drawings.

The present disclosure provides a separator for a secondary battery which is formed of a porous sheet in which the porous sheet includes polymer and boron nitride nanotubes. The separator for a secondary battery of the present disclosure is a porous sheet and has a single layer structure in which boron nitride nanotubes form a network in the polymer separator.

According to an embodiment of the present disclosure, the porous sheet may be a porous film or a nonwoven fiber web and one of components which configure the porous film, or the unwoven fiber web is a polymer.

According to an embodiment of the present disclosure, the polymer may be one or more selected from the group consisting of polyvinylidene fluoride (PVdF), polyvinylidene fluoride-co-hexafluoropropylene (PVdF-HFP), polyvinylidene fluoride-co-trichloroethylene, polymethylmethacrylate, polyacrylonitrile, polyvinylpyrrolidone, polyvinylacetate, polyethylene-co-vinyl acetate, cellulose acetate, cellulose acetate butyrate, cellulose acetate propionate, cyanoethylpullulan, cyanoethylpolyvinylalcohol, cyanoethylcellulose, cyanoethylsucrose, pullulan, carboxyl methyl cellulose, acrylonitrile-styrenebutadiene copolymer, polyimide, styrene butadiene rubber (SBR), carboxymethylcellulose, polyethylene oxide, polyepichlorohydrin, polyphosphazene, polyvinylpyridine, chlorosulfonated polyethylene, latex, polyester resin, acrylic resin, epoxy resin, polyvinyl alcohol, hydroxypropyl cellulose, and polyolefin, but is not limited thereto.

The separator for a secondary battery of the present disclosure is formed of a porous sheet and at this time, the porous sheet may be a porous film or a non-woven fiber web.

When the separator for a secondary battery is a porous film, the porous film has a structure in which a polymer is formed as a matrix and the boron nitride nanotubes are embedded in the matrix to form a network.

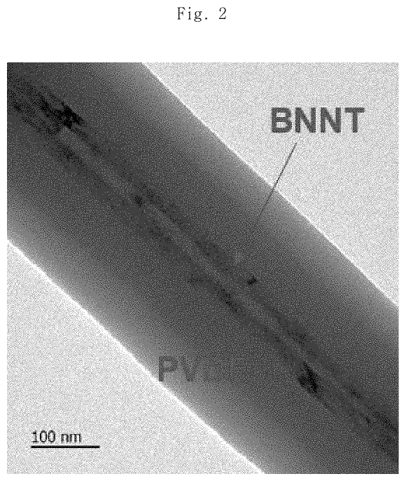

When the separator for a secondary battery of the present disclosure is a non-woven fiber web, the non-woven web has a structure in which the polymer configures a plurality of fibers which forms an assembly which is two-dimensionally randomly and continuously connected in a plan view and at this time, the boron nitride nanotubes are embedded in the fiber in the same direction as illustrated in FIG. 2.

Further, the separator for a secondary battery of the present disclosure may have a structure in which the boron nitride nanotubes are bonded by the polymer to form a sheet shape.

The separator for a secondary battery of the present disclosure includes boron nitride nanotubes so that the separator fora secondary battery has excellent insulation and enables the weight reduction of the separator for a secondary battery unlike the case that planar or particulate inorganic material having a high density is used.

According to an embodiment of the present disclosure, the porous sheet may include 2 to 90 parts by weight or 5 to 90 parts by weight, or 20 to 50 parts by weight of boron nitride nanotubes based on 100 parts by weight of polymer. When the boron nitride nanotubes are included in the porous sheet with the weight ratio within the above-mentioned range, thermal stability, mechanical strength, and electrical insulation desirable for the separator may be simultaneously provided.

According to an embodiment of the present disclosure, the boron nitride nanotubes may have an average external diameter in the range of 10 nm to 100 nm, or 30 nm to 50 nm and have an average length in the range of 1 μm to 50 μm, or 5 μm to 20 μm or an average length of 10 μm. Further, the boron nitride nanotubes have an aspect ratio in the range of 10 to 5000 or 100 to 1000 and the aspect ratio is a value obtained by dividing a length of the boron nitride nanotube by an external diameter of the boron nitride nanotube. When the boron nitride nanotube has an external diameter, an average length and/or an aspect ratio in the above-mentioned range, the boron nitride nanotubes are uniformly embedded in the porous film or the web fiber to contribute to the improvement of the thermal stability, the mechanical strength, and the electric insulation of the separator for a secondary battery.

According to an embodiment of the present disclosure, the boron nitride nanotube has a bulk density of 2.0 g/cm³ to 2.2 g/cm³. When the boron nitride nanotube has a density in the above-mentioned range, it may contribute to the reduction of the weight of the separator for a secondary battery while allowing the separator for a secondary battery including the boron nitride nanotubes to have the excellent thermal stability, mechanical strength, and electric insulation.

According to an embodiment of the present disclosure, the separator for a secondary battery may have a thickness in the range of 1 μm to 100 μm, 3 μm to 50 μm, 5 μm to 30 μm, or 7 μm to 20 μm. When the separator for a secondary battery has a thickness in the above-mentioned range, the mechanical strength and the thermal stability suitable for the separator for a secondary battery may be provided and an unnecessary volume increase of the lithium secondary battery may be suppressed.

According to an embodiment of the present disclosure, the separator for a secondary battery may have a density in the range of 0.1 g/cm³ to 1.0 g/cm³, 0.2 g/cm³ to 0.7 g/cm³, or 0.3 g/cm³ to 0.7 g/cm³. This corresponds to a characteristic that the weight is lighter than that of the related art. The mechanical strength and the thermal stability suitable for the separator for a secondary battery may be provided and the unnecessary volume increase of the lithium secondary battery may be suppressed.

According to an embodiment of the present disclosure, the separator for a secondary battery may have porosity in the range of 10% to 95%, 20% to 80%, 30% to 70%, or 40% to 60%. When the separator for a secondary battery has the porosity in the above-mentioned range, the separator may easily absorb the electrolyte and appropriately adjust the mobility of the ions. The porosity was measured by a mercury pressure porosimetry using AutoPore V 9600 device (by Micrometrics) and a measurable size range of the pores is 0.003 μm to 900 μm. In order to measure the porosity and the average diameter of the pores, a diameter of fine pores which are filled with mercury at a predetermined pressure was measured by ASTM D 4284-92 standard, and fine pores were measured at each predetermined pressure while continuously applying a pressure in the range of the pressure of 0.5 to 60,000 psi, and a volume of the mercury which was filled in the separator was measured to measure the porosity. The measurement was automatically performed to output a calculated value.

According to an embodiment of the present disclosure, the separator for a secondary battery may have an average pore diameter in the range of 0.1 μm to 3.0 μm, or 0.5 μm to 2.0 μm. When the separator for a secondary battery has the pores in the above-mentioned range, the separator may be used as a separator having an appropriate ion conductivity and mechanical strength.

According to an embodiment of the present disclosure, the separator for a secondary battery has a thermal shrinkage in the range of 0 to 10% or 0 to 5% after the thermal treatment at 170° C. for 30 minutes and a thermal shrinkage in the range of 0 to 20% or 0 to 10% after the thermal treatment at 200° C. for 30 minutes. When the separator for a secondary battery of the present disclosure has a thermal shrinkage within the predetermined range, it exhibits the stability at the high temperature. The thermal shrinkage is calculated by preparing a specimen by cutting a specimen of a separator for a secondary battery to be a circle having a predetermined size, maintaining it in an oven heated at 170° C. or 200° C. for 30 minutes, and then withdrawing the specimen and measuring the changed diameter: Shrinkage (%)={(Diameter before shrinkage−Diameter after shrinkage)/Diameter before shrinkage}×100

According to an embodiment of the present disclosure, the separator for a secondary battery has a tensile strength in the range of 1 to 10 MPa or 2 to 8 MPa. When the separator for a secondary battery of the present disclosure has the tensile strength in the above-mentioned range, the stability of the secondary battery may be ensured. When the porous sheet of the separator for a secondary battery is a porous film, the tensile strength is measured at a tensile speed of 5 mm/min and an initial distance between jigs of 25 mm and when the porous sheet of the separator for a secondary battery is a non-woven fiber web, the tensile strength is measured at a tensile speed of 50 mm/min and an initial distance between jigs of 15 mm.

Further, the present disclosure provides a manufacturing method of a separator for a secondary battery.

According to an embodiment of the present disclosure, the manufacturing method of a separator for a secondary battery may include the following steps.

(1) A boron nitride nanotube and a solvent are prepared and the boron nitride nanotube is dispersed in the solvent.

For the boron nitride nanotubes, refer to the above-description.

The solvent is used as a dispersion medium for the boron nitride nanotubes, and is used as a solvent for the polymer which is added thereafter. For example, methylformamide, dimethylacetamide, acetone, methylpyrrolidone (N,N-Methylpyrrolidone), or a mixture thereof may be used, but is not limited thereto. For example, a solvent in which dimethylacetamide and acetone are mixed at a volume ratio of 4:6 may be used.

The boron nitride nanotube may be used with an amount of 1 to 20 parts by weight, 1 to 10 parts by weight, or 1 to 5 parts by weight based on 100 parts by weight of the solvent. When the boron nitride nanotube is used with the above-mentioned amount, the thermal stability, the mechanical strength, and the insulation to be achieved by the present disclosure may be obtained while ensuring the uniform dispersibility of the boron nitride nanotubes.

In order to improve the uniformity of the boron nitride nanotube, an ultrasonic wave may be applied to the dispersion to which the boron nitride nanotube is added. The ultrasonic wave may be tip-ultrasonic dispersion, or bath ultrasonic dispersion, or both of them.

(2) Polymer is added to the composition prepared in (1).

For a type of available polymer, refer to the above-description.

According to an embodiment of the present disclosure, the polymer may be a pellet or a powder type, but may also be a liquid type and is soluble in the above-mentioned solution.

The polymer may be added to have an amount such that the boron nitride nanotube is 2 to 90 parts by weight or 5 to 90 parts by weight, or 20 to 50 parts by weight based on 100 parts by weight of polymer.

In order to homogeneously disperse the polymer in the composition prepared in (1), the agitation treatment may be performed under application of heat. The agitation may be performed in the hot plate of 70° C. for four hours. For example, in order to improve the dispersibility of the boron nitride nanotube, an ultrasonic wave such as a tip ultrasonic wave may be applied for two minutes or more and if necessary, it is performed in a vacuum container to remove bubbles. Further, if necessary, in order to homogeneously disperse the boron nitride nanotube in the polymer composition, an ultrasonic wave such as a bath ultrasonic wave may be applied for 20 minutes or more.

(3) A porous sheet is provided by casting or electro spinning a boron nitride nanotube dispersion.

When the separator is manufactured by a porous film, the polymer composition including the boron nitride nanotube is coated by a die coating process and then dried for 20 to 60 seconds at a temperature in the range of 120° C. to 170° C. According to the present disclosure, the pores are formed in the film by the drying process to obtain the porous film so that the processes performed to form pores in the related art in the field, for example, a film stretching process, an immersion phase separation process or a humidified phase separation process for moving binder polymer are not required. Therefore, it is advantageous in that the manufacturing process is simplified.

When the separator is manufactured by a non-woven fiber web, after electro spinning the polymer composition in which the boron nitride nanotubes are dispersed, the output of the spinning step is compressed, dried, and heated-stretched to obtain a non-woven fiber web type separator fora secondary battery. The electro spinning may be performed for 30 minutes under the condition of 15 kV, a tip-to-collector distance (TDC) of 10 cm, an ejection amount of 20 μl/min, and No. 25 needle.

The present disclosure also provides a secondary battery including the above-described separator for a secondary battery.

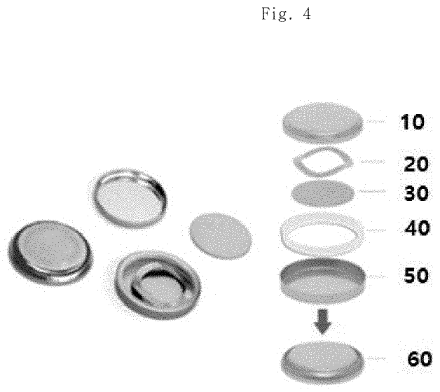

In FIG. 4, a disassembled state of a coin cell which is one aspect of the secondary battery has been described, but the secondary battery is not limited to the coin cell. Referring to FIG. 4, the coin cell is configured by a cap 10, a wave washer 20, a spacer 30, a polypropylene (PP) gasket 40, a case 50, and a finish 60.

According to an embodiment of the present disclosure, the lithium secondary battery may be a lithium ion battery or a lithium ion polymer battery and may include a cathode, an anode, a separator, and an electrolyte.

The cathode may, for example, be prepared by applying a cathode mixture in which a cathode active material, a conductive material, and a binder polymer are mixed to a cathode current collector and if necessary, a filler may be further added to the cathode mixture.

The cathode current collector is generally prepared to have a thickness of 3 μm to 300 μm and the cathode current collector is not specifically limited as long as the cathode current collector has a high conductivity without causing a chemical change on the battery. For example, the cathode current collector may include one selected from stainless steel, aluminum, nickel, titanium, and aluminum or stainless steel surface treated with carbon, nickel, titanium, or silver, and more specifically, use aluminum. The current collector allows the binding strength of the cathode active material to be increased by forming fine irregularities on the surface thereof, and may be used in various forms such as a film, a sheet, a foil, a net, a porous body, a foam body, a non-woven fabric body, and the like.

The cathode active material may include, for example, a layered compound such as lithium cobalt oxide (LiCoO₂) or lithium nickel oxide (LiNiO₂), a compound substituted with one or more transition metals; lithium iron phosphate oxide such as LiFePO₄; lithium manganese oxides of chemical formula Li₁₊ₓMn₂₋ₓO₄ (where x is 0 to 0.33), LiMnO₃, LiMn₂O₃, LiMnO₂, and the like; lithium copper oxide (Li₂CuO₂); vanadium oxide such as LiV₃O₈, LiV₃O₄, V₂O₅, and Cu₂V₂O₇; Ni site-type lithium nickel oxide represented by chemical formula LiNi₁₋ₓO₂ (wherein M=Co, Mn, Al, Cu, Fe, Mg, B or Ga, and x=0.01 to 0.3); lithium manganese composite oxide represented by chemical formula LiMn₂₋ₓMₓO₂ (where M=Co, Ni, Fe, Cr, Zn or Ta, and x=0.01 to 0.1) or Li₂Mn₃MO₈ (where M=Fe, Co, Ni, Cu or Zn); LiMn₂O₄ in which apart of Li in chemical formula is substituted with an alkaline earth metal ion; disulfide compounds; and Fe₂(MoO₄)₃, but is not limited thereto.

The conductive material is added with an amount of 1 to 30% by weight based on a total weight of the cathode mixture including the cathode active material. The conductive material is not specifically limited as long as the conductive material has a conductivity without causing a chemical change on the battery, and for example, may use graphite such as natural graphite or artificial graphite; carbon black, such as carbon black, acetylene black, Ketjen black, channel black, furnace black, lamp black, and summer black; conductive fibers such as carbon fibers and metal fibers; metal powders such as carbon fluoride, aluminum, and nickel powder; conductive whiskeys such as zinc oxide and potassium titanate; conductive metal oxides such as titanium oxide; and conductive materials such as polyphenylene derivatives.

The binder polymer included in the cathode and the anode is a component which assists the bonding of the active material and the conductive material and the bonding with the current collector and is typically added with 1 to 30% by weight based on a total weight of the mixture including the cathode active material. Examples of the binder polymer include polyvinylidene fluoride, polyvinyl alcohol, carboxymethyl cellulose (CMC), starch, hydroxypropyl cellulose, regenerated cellulose, polyvinyl pyrrolidone, tetrafluoroethylene, polyethylene, polypropylene; ethylene-propylene-diene terpolymer (EPDM), sulfonated EPDM, styrene-butadiene rubber, fluorine rubber, various copolymers, and the like.

In the meantime, the anode may be prepared by applying an anode mixture including an anode active material, a conductive material, and a binder polymer onto the anode current collector and optionally further include a filler, etc.

The anode current collector is not particularly limited as long as it has conductivity without causing a chemical change in the corresponding battery, and for example, uses copper, stainless steel, aluminum, nickel, titanium, baked carbon, or copper, or stainless steel surface treated with carbon, nickel, titanium, silver, and an aluminum-cadmium alloy. In addition, like the cathode current collector, fine irregularities may be formed on the surface thereof to increase the binding strength of the anode active material, and the current collector may be used in various forms such as film, sheet, foil, net, porous body, foam body, non-woven fabric body, and the like.

In the present disclosure, the thickness of the anode current collector may be the same within the range of 3 to 300 μm, but may have different values if necessary.

The anode active material includes, for example, carbon such as non-graphitizable carbon and graphitic carbon; metal complex oxides such as LiₓFe₂O₃(0<x<1), LiₓWO₂ (0<x<1), SnₓMe₁₋ₓMe′_{y}O_{z} (Me: Mn, Fe, Pb, Ge; Me′: Al, B, P, Si, Group 1, Group 2, and Group 3 elements of the periodic table, and halogens; 0<x<1; 1<y<3; 1<z<8); lithium metal; lithium alloy; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; and Li—Co—Ni-based materials.

The electrolyte may be a lithium salt-containing non-aqueous electrolyte, and the lithium salt-containing non-aqueous electrolyte includes a non-aqueous electrolyte and a lithium salt. As the non-aqueous electrolyte, a non-aqueous organic solvent, an organic solid electrolyte, and an inorganic solid electrolyte are used, but is not limited thereto.

Examples of the non-aqueous organic solvent include aprotic organic solvents such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydroxyfuran, 2-methyl tetrahydrofuran, dimethyl sulfoxide, 1,3-dioxolane, formamide, dimethylformamide, dioxolane, acetonitrile, nitromethane, methyl formate, methyl acetate, triester phosphate, trimethoxy methane, dioxolane derivatives, sulfolane, methyl sulfolane, 1,3-dimethyl-2-imidazolidinone, propylene carbonate derivatives, tetrahydrofuran derivatives, ethers, methyl pyropionate, and ethyl propionate.

The lithium salt is a material easily soluble in the non-aqueous electrolyte, for example, uses LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, (CF₃SO₂)₂NLi, chloro borane lithium, lower aliphatic lithium carboxylate, tetraphenyl lithium borate, imide, or the like.

The present disclosure further provides a battery pack including the secondary battery as a unit battery and a device including the battery pack as a power source.

The device is, for example, a notebook computer, a netbook, a tablet PC, a mobile phone, an MP3, a wearable electronic device, a power tool, an electric vehicle (EV), a hybrid electric vehicle (HEV), a plug-in hybrid electric vehicle (PHEV), an electric bicycle (E-bike), an electric scooter (E-scooter), an electric golf cart, or a system for power storage, but is not limited thereto.

The structure and the manufacturing method of the device have been widely known in the art so that a detailed description thereof will be omitted in this specification.

On the other hand, although specific embodiments have been described in the description of the present disclosure, various modifications are possible without departing from the scope of the technical spirit included in the various embodiments. Therefore, the scope of the present disclosure is not limited to the Examples described, but should be defined by the Claims to be described below and equivalents to the Claims.

### EXAMPLES

### Example 1-1: Separator for Secondary Battery Prepared by Electro Spinning Composition Including Boron Nitride Nanotube of 5% by Weight Based on Polyvinylidene Fluoride (PVDF)

4.45 g of a solvent obtained by mixing dimethyl acetamide and acetone with a weight ratio of 4:6 was prepared. 0.05 g of a boron nitride nanotube (an average external diameter of 40 nm, a length of 10 μm, a bulk density of 2.2 g/cm³) was added thereto, a tip ultrasonic wave was applied for one minute, and a bath ultrasonic wave was applied for 30 minutes to improve dispersibility.

0.95 g of polyvinylidene fluoride (PVdF) pellets (Sigma-Aldrich, molecular weight (MW: 275,000)) were added to a solvent in which boron nitride nanotubes were dispersed, and the mixture was agitated on a hot plate at 70° C. for 4 hours. The tip ultrasonic wave was applied for 2 minutes to improve dispersibility of the boron nitride nanotubes. The bath ultrasonic wave was applied for 20 minutes to remove bubbles in the PVdF.

The composition obtained from the above was electrospun for 30 minutes using an applied voltage of 15 kV, a tip-to-collector Distance (TCD) of 10 cm, a discharge amount of 20 μl/min, and a 25 G needle to obtain a separator for a secondary battery formed of a nonwoven fabric web having a thickness of 24 μm.

### Example 1-2: To Manufacture Secondary Battery

A 2030 coin cell was prepared by using lithium foil (manufactured by Goodfellow, with a thickness of 0.2 mm and a purity of 99.9%) as anode active material, using LiFePO₄ (manufactured by Sigma-Aldrich, with an average powder size<5 μm) as a cathode active material, applying 1 M of LiPF₆ to the mixture of ethylene carbonate and dimethyl carbonate with a weight ratio of 1:1 as an electrolyte, and interposing the separator for a secondary battery of Example 1-1 between the cathode and the anode.

### Example 2-1: Separator for Secondary Battery Prepared by Bar-Coating Composition Including Boron Nitride Nanotube of 5% by Weight Based on PVdF

4.45 g of a solvent obtained by mixing dimethyl acetamide and acetone with a weight ratio of 4:6 was prepared. 0.05 g of a boron nitride nanotube (an average external diameter of 40 nm, a length of 10 μm, a density of 2.2 g/cm³) was added thereto, a tip ultrasonic wave was applied for one minute, and a bath ultrasonic wave was applied for 30 minutes to improve dispersibility.

0.95 g of PVdF pellets which were the same as used in Example 1 were added to a solvent in which boron nitride nanotubes were dispersed, and the mixture was agitated on a hot plate at 70° C. for 4 hours. The tip ultrasonic wave was applied for 2 minutes to improve dispersibility of the boron nitride nanotubes. The bath ultrasonic wave was applied for 20 minutes to further improve the dispersibility of the boron nitride nanotubes in the PVdF.

The composition obtained above was spread on a polyethylene terephthalate (PET) release film at a feed rate of 10 mm/min using a bar coater and was dried at a room temperature (25° C.) for 24 hours. Thereafter, the composition was subject to the thermal treatment in an oven set at 80° C. for 4 hours and then withdrawn from the oven. The porous film was released from the PET release film to obtain a separator for a secondary battery in the form of a porous film with a thickness of 40 μm.

### Example 2-2: To Manufacture Secondary Battery

A 2032 coin cell was prepared by the same method as Example 1-2 except that the separator for a secondary battery of Example 2-1 was used.

### Example 3-1: Separator for Secondary Battery Prepared by Electro Spinning Composition Including Boron Nitride Nanotube of 10% by Weight Based on Polyvinylidene Fluoride (PVDF)

4.45 g of a solvent obtained by mixing dimethyl acetamide and acetone with a weight ratio of 4:6 was prepared. 0.1 g of a boron nitride nanotube (an average external diameter of 40 nm, a length of 10 μm, a bulk density of 2.2 g/cm³) was added thereto, a tip ultrasonic wave was applied for one minute, and a bath ultrasonic wave was applied for 30 minutes to improve dispersibility.

0.9 g of polyvinylidene fluoride (PVdF) pellets (Sigma-Aldrich, molecular weight (MW: 275,000)) were added to a solvent in which boron nitride nanotubes were dispersed, and the mixture was agitated on a hot plate at 70° C. for 4 hours. The tip ultrasonic wave was applied for 2 minutes to improve dispersibility of the boron nitride nanotubes. The bath ultrasonic wave was applied for 20 minutes to remove bubbles in the PVdF.

The composition obtained from the above was electrospun for 30 minutes using an applied voltage of 15 kV, a tip-to-collector Distance (TCD) of 10 cm, a discharge amount of 20 μl/min, and a 25 G needle to obtain a separator for a secondary battery formed of a nonwoven fabric web having a thickness of 24 μm.

### Example 3-2: To Manufacture Secondary Battery

A 2032 coin cell was prepared by the same method as Example 1-2 except that the separator for a secondary battery of Example 3-1 was used.

### Example 4-1: Separator for Secondary Battery Prepared by Bar-Coating Composition Including Boron Nitride Nanotube of 10% by Weight Based on PVdF

4.45 g of a solvent obtained by mixing dimethyl acetamide and acetone with a weight ratio of 4:6 was prepared. 0.1 g of a boron nitride nanotube (an average external diameter of 40 nm, a length of 10 μm, a density of 2.2 g/cm³) was added thereto, a tip ultrasonic wave was applied for one minute, and a bath ultrasonic wave was applied for 30 minutes to improve dispersibility.

0.9 g of PVdF pellets which were the same as used in Example 1 were added to a solvent in which boron nitride nanotubes were dispersed, and the mixture was agitated on a hot plate at 70° C. for 4 hours. The tip ultrasonic wave was applied for 2 minutes to improve dispersibility of the boron nitride nanotubes. The bath ultrasonic wave was applied for 20 minutes to further improve the dispersibility of the boron nitride nanotubes in the PVdF.

The composition obtained above was spread on a polyethylene terephthalate (PET) release film at a feed rate of 10 mm/min using a bar coater and was dried at a room temperature (25° C.) for 24 hours. Thereafter, the composition was subject to the thermal treatment in an oven set at 80° C. for 4 hours and then withdrawn from the oven. The porous film was released from the PET release film to obtain a separator for a secondary battery in the form of a porous film with a thickness of 40 μm.

### Example 4-2: To Manufacture Secondary Battery

A 2032 coin cell was prepared by the same method as Example 1-2 except that the separator for a secondary battery of Example 4-1 was used.

### Comparative Example 1-1: Separator for Secondary Battery Prepared by Electro Spinning Neat PVdF Solution

5 g of a solvent obtained by mixing dimethyl acetamide and acetone with a weight ratio of 4:6 was prepared. 1 g of PVdF pellets which were the same as used in Example 1-1 were dissolved therein and agitated on a hot plate at 70° C. for 4 hours. The bath ultrasonic wave was applied for 20 minutes to remove bubbles in the PVdF.

The composition obtained from the above was electrospun for 30 minutes using an applied voltage of 15 kV, TCD of 10 cm, a discharge amount of 20 μl/min, and a 25G needle to obtain a separator for a secondary battery formed of a nonwoven fabric web having a thickness of 24 μm.

### Comparative Example 1-2: To Manufacture Secondary Battery

A 2032 coin cell was prepared by the same method as Example 1-2 except that the separator for a secondary battery of Comparative Example 1-1 was used.

### Comparative Example 2-1: Separator for Secondary Battery Prepared by Bar-Coating Neat PVdF Solution

5 g of a solvent obtained by mixing dimethyl acetamide and acetone in a weight ratio of 4:6 was prepared. 1 g of polyvinylidene fluoride (PVdF) pellets which were the same as those used in Example 1-1 were dissolved therein and agitated on a hot plate at 70° C. for 4 hours. The bath ultrasonic wave was applied for 20 minutes to remove bubbles in the PVdF.

The composition obtained above was spread on a polyethylene terephthalate (PET) film at a feed rate of 10 mm/min using a bar coater and was dried at a room temperature (25° C.) for 24 hours. Thereafter, the composition was subject to the thermal treatment in an oven set at 80° C. for 4 hours and then withdrawn from the oven. The porous film was released from the PET film to obtain a separator for a secondary battery in the form of a porous film with a thickness of 40 μm.

### Comparative Example 2-2: To Manufacture Secondary Battery

2032 coin cell was prepared by the same method as Example 1-2 except that the separator for a secondary battery of Comparative Example 2-1 was used.

### Comparative Example 3-1: Separator for Secondary Battery Including Alumina Coating Layers on Both Surfaces of Separator of Comparative Example 2-1

5 g of a solvent obtained by mixing dimethyl acetamide and acetone in a weight ratio of 4:6 was prepared. 0.95 g of PVdF pellets which were the same as used in Example 1-1 were dissolved therein and agitated on a hot plate at 70° C. for 4 hours. The bath ultrasonic wave was applied for 20 minutes to remove bubbles in the PVdF. An alumina dispersion was prepared by adding 0.05 g of alumina nanoparticles (Shanghai Xinglu Chemical Technology, a purity of 99.9%, an average particle size of 500 nm), dispersing the particles using a tip ultrasonic wave and a bath ultrasonic wave and was coated and dried on both surfaces of the separator prepared in Comparative Example 2-1 by bar-coating to obtain a separator for a secondary battery. By doing this, the separator for a secondary battery in which alumina inorganic nanoparticles with a thickness of 62 μm were coated on both surfaces was obtained.

### Comparative Example 3-2: To Manufacture Lithium Secondary Battery

A 2032 coin cell was prepared by the same method as Example 1-2 except that the separator for a secondary battery of Comparative Example 3-1 was used.

### Evaluative Example

### 1. SEM/TEM Photographs

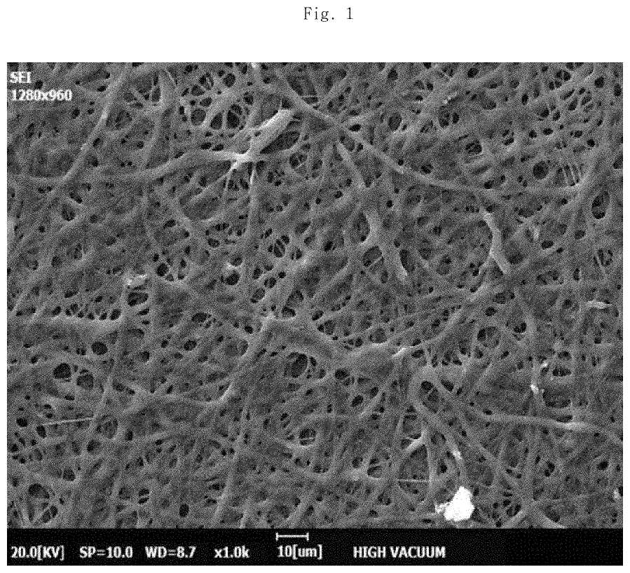

As seen from FIG. 1, it was confirmed that as the separator for a secondary battery of Example 1-1, a separator for a secondary battery having a non-woven fiber web type in which fibers having a relatively uniform diameter of 500 nm to 1 μm were spun without having directionality was prepared. Further, as seen from FIG. 2, it was determined that in the polyvinylidene fluoride polymer fiber phase of Example 1-1, boron nitride nanotubes were present in the same direction to improve the heat resistance and mechanical properties of the separator for a secondary battery.

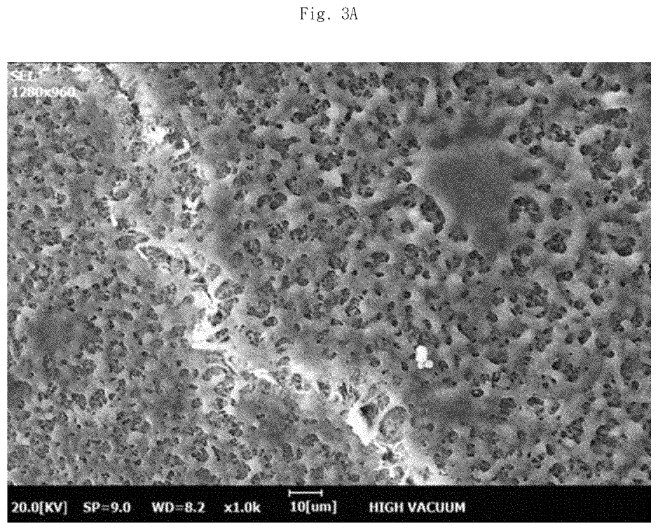

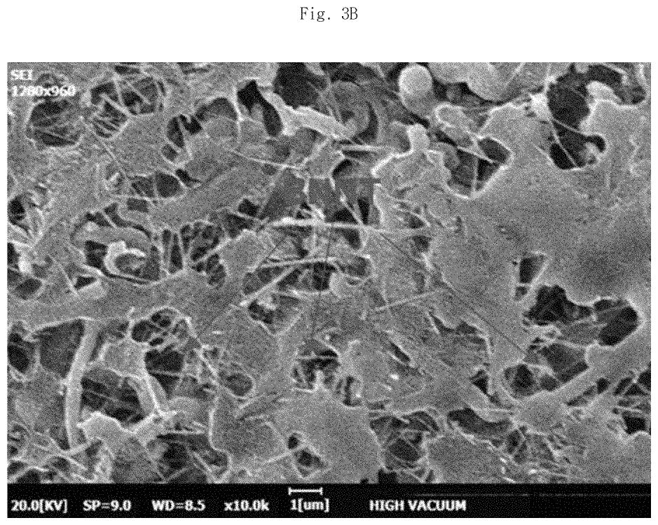

As seen from FIGS. 3A and 3B, it was confirmed that the separator for a secondary battery of Example 2-1 was formed as a network in which a bead shape was connected by boron nitride nanotubes, so that the boron nitride nanotubes in the composition of the boron nitride nanotubes and polyvinylidene fluoride connected the bead shaped polymers to improve heat resistance and mechanical properties.

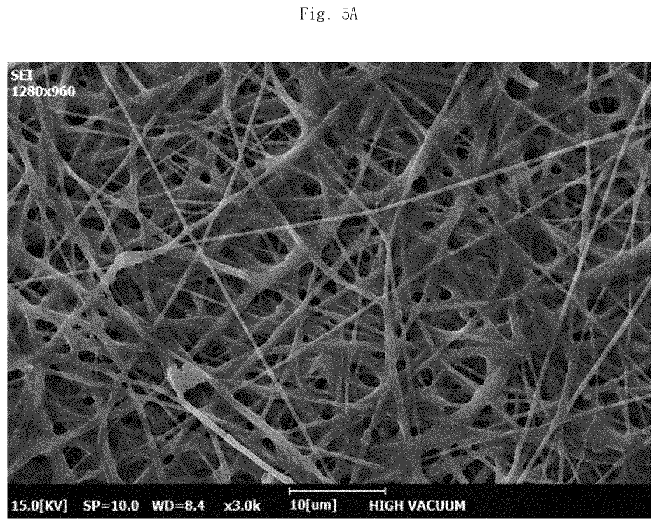

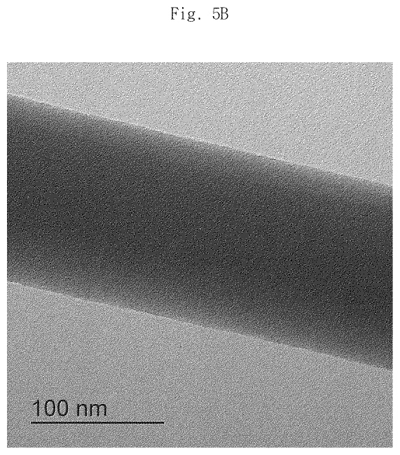

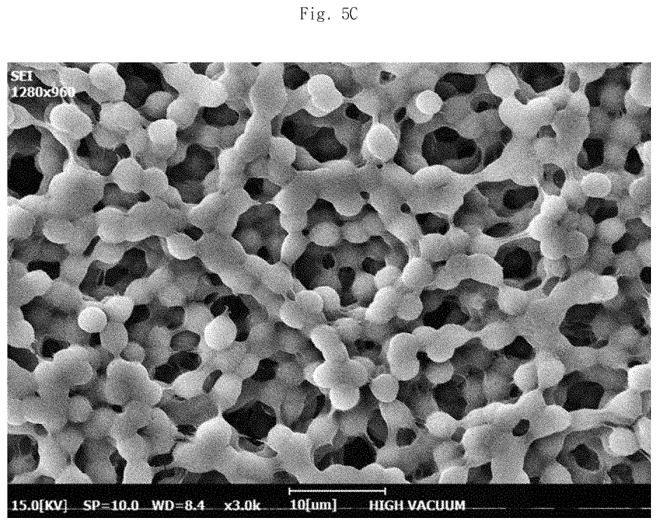

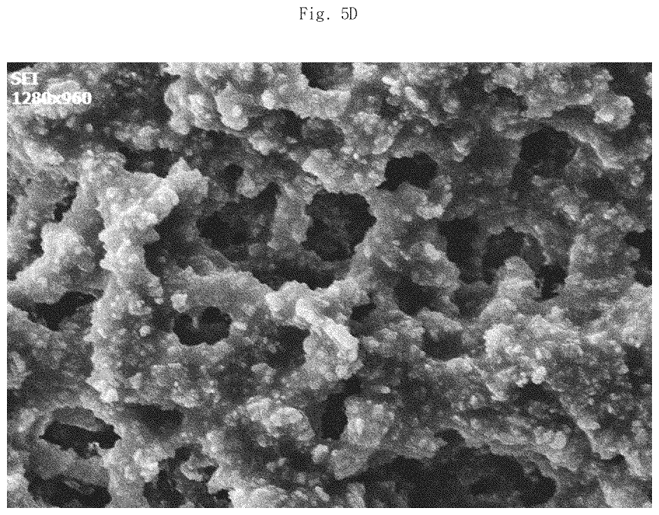

As seen from FIG. 5A, it was confirmed that the separator for a secondary battery electrospun with neat polyvinylidene fluoride polymer of Comparative Example 1-1 was similar in appearance to the separator configured by boron nitride nanotubes and polyvinylidene fluoride polymer of FIG. 1, but as seen from the TEM photograph of FIG. 5B, there was no boron nitride nanotube in the polyvinylidene fluoride fiber phase. FIG. 5C is a SEM photograph of a neat PVDF bar-coating separator in which polymer beads are formed to configure pores, but it is confirmed that there is no boron nitride nanotube network as illustrated in FIGS. 3A and 3B. FIGS. 5D and 5E illustrate a plan view and a cross-sectional side view of the SEM in which the separator prepared in Comparative Example 3-1 is coated with alumina.

### 2. Thermal Stability: Thermal Shrinkage

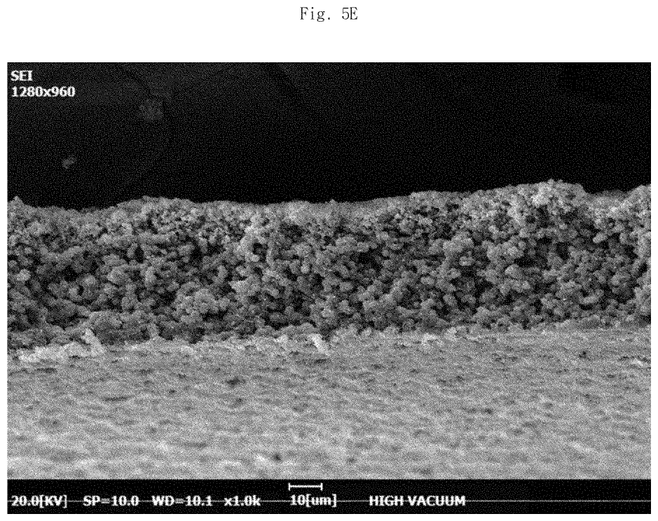

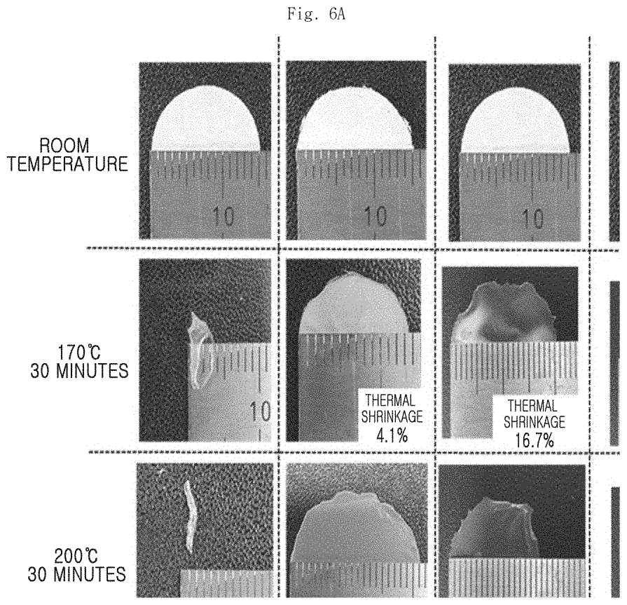

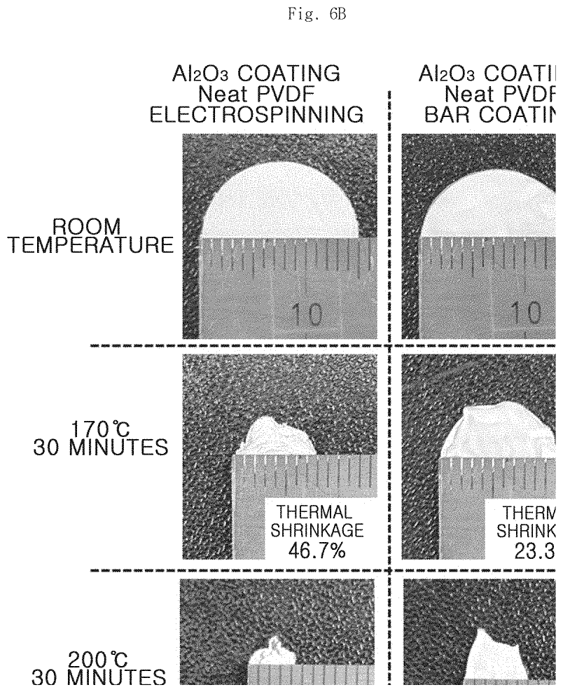

The thermal shrinkage was calculated by preparing a circular specimen having a predetermined size from a separator for a secondary battery obtained from Comparative Examples 1-1, 2-1, and 3-1 and Examples 1-1 and 2-1 and withdrawing the specimen after thermal treatment at 170° C. and 200° C. for 30 minutes, and measuring a size change (see FIGS. 6A and 6B): Shrinkage (%)={(Diameter before shrinkage−Diameter after shrinkage)/Diameter before shrinkage}×100.

As a result, it was confirmed that the separator for a secondary battery of Example 1-1 had a thermal shrinkage of 4.1% at 170° C. and a thermal shrinkage of 9.5% at 200° C.

It was confirmed that the separator for a secondary battery of Example 2-1 had a thermal shrinkage of 6.3% at 170° C. and a thermal shrinkage of 10.4% at 200° C.

The separator for a secondary battery of Comparative Example 1-1 was melted at 170° C. and 200° C. so that a circular shape was not maintained. Therefore, the thermal shrinkage could not be measured.

It was confirmed that the separator for a secondary battery of Comparative Example 3-1 had a thermal shrinkage of 23.3% at 170° C. In this case, the neat separator of the related art which was coated with inorganic alumina nanoparticles showed a low thermal stability as compared with the thermal shrinkage of the separator using the boron nitride nanotubes proposed by the present disclosure.

### 3. Measurement of Porosity

Porosities of the separator for a secondary battery of Examples 1-1 and 2-1 before thermal treatment, after thermal treatment at 170° C., and after thermal treatment at 200° C. were measured by the mecurimetric method using Autopore V 9600 device (Micrometrics) and the following result was obtained therefrom.

TABLE 1

| | | | After thermal |
|---|---|---|---|
| | Before thermal | After thermal | treatment at |
| | treatment | treatment at 170° C. | 200° C. |
| | Average diameter | Average diameter | Average diameter |
| | of pores (μm)/ | of pores (μm)/ | of pores (μm)/ |
| | Porosity (%) | Porosity (%) | Porosity (%) |
| Example 1-1 | 2.5/65.0 | 2.8/67.5 | 2.8/68.0 |
| Example 2-1 | 1.05/55 | 0.89/54 | 1.85/52 |

From the above description, the separator for a secondary battery of Example 1-1 showed a porosity of approximately 65% both before and after the thermal treatment and it was determined that the porosities before and after the thermal treatment were substantially the same in consideration of a measurement error. It was confirmed that the porosity of the separator for a secondary battery of Example 2-1 was slightly reduced as the thermal treatment temperature increased, but it was confirmed that the porosity of 50% or higher was maintained as a whole.

### 4. Tensile Strength/Strain at the Time of Rupture

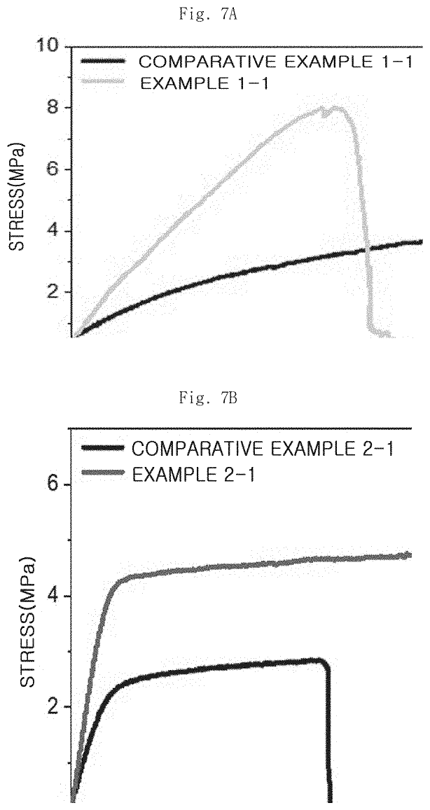

Specimens were prepared from the separators for a secondary battery prepared by Comparative Example 1-1, Example 1-1, Comparative Example 2-1, and Example 2-1 to measure tensile stresses and strains at the time of rupture and the results were illustrated in FIGS. 7A and 7B.

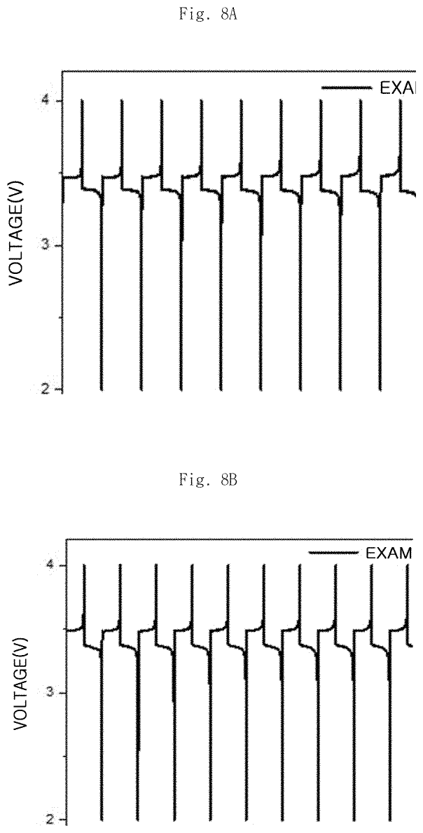

The separators for a secondary battery of Example 1-1 and Comparative Example 1-1 were stretched at a speed of 50 mm/min by setting an initial distance between jigs to 15 mm and the separators for a secondary battery of Example 2-1 and Comparative Example 2-1 were stretched at a speed of 5 mm/min by setting an initial distance between jigs to 25 mm to perform the test. It was confirmed that the mechanical properties of the separators prepared by Examples 1-1 and 2-1 were improved twice or more as compared with the separator prepared by Comparative Examples 1-1 and 2-1. As a result, it was confirmed from the graphs of FIGS. 8A and 8B that the separator for a secondary battery prepared by the present disclosure had a tensile strength which was equal to or higher than a value which was generally accepted in the art.

### 5. Evaluation Method of Charging/Discharging Property of Lithium Secondary Battery and Result

With respect to the secondary battery of Examples 1-2 and 2-2, a charging/discharging experiment was performed with a voltage condition of 2 to 4 V and a current condition of 0.1 mA which were generally applied to confirm an operability and applicability of the separator for a secondary battery.

The charging/discharging experiment is performed using the 2032 coin cell configured with the structure illustrated in FIG. 4 and a diameter of the separator applied thereto is 18 mm. As the cathode and the anode, lithium foil and LiFePO₄ are used and the electrolyte is a solution in which EC:DMC (Ethylene carbonate:Dimethyl carbonate) are mixed with a volume ratio of 1:1 and 1 mole of LiPF₆ is melted.

The results were illustrated in FIGS. 8A and 8B and it was confirmed that the separators for a secondary battery of Examples 1-1 and 2-1 normally functioned as separators and as a result, the lithium secondary battery was smoothly charged/discharged.

The present disclosure is not limited to the embodiments and may be prepared in various forms, and it will be understood by a person with ordinary skill in the art, to which the present disclosure pertains, that the present invention may be implemented in other specific forms without modifying the technical spirit or essential feature of the present disclosure. Thus, it is to be appreciated that the embodiments described above are intended to be illustrative in every sense, and not restrictive.

What is claimed is:

1. A separator for a secondary battery which is formed of a single layer of porous sheet,
wherein the porous sheet includes a polymer matrix and boron nitride nanotubes which are embedded in the matrix.

2. The separator for a secondary battery according to claim 1, wherein the boron nitride nanotubes forma network in the polymer.

3. The separator for a secondary battery according to claim 1, wherein the polymer is selected from the group including polyvinylidene fluoride (PVdF), polyvinylidene fluoride-co-hexafluoropropylene (PVdF-HFP), polyvinylidene fluoride-co-trichloroethylene, polymethylmethacrylate, polyacrylonitrile, polyvinylpyrrolidone, polyvinylacetate, polyethylene-co-vinyl acetate, cellulose acetate, cellulose acetate butyrate, cellulose acetate propionate, cyanoethylpullulan, cyanoethylpolyvinylalcohol, cyanoethylcellulose, cyanoethylsucrose, pullulan, carboxyl methyl cellulose, acrylonitrile-styrenebutadiene copolymer, polyimide, styrene butadiene rubber (SBR), carboxymethylcellulose, polyethylene oxide, polyepichlorohydrin, polyphosphazene, polyvinylpyridine, chlorosulfonated polyethylene, latex, polyester resin, acrylic resin, epoxy resin, polyvinyl alcohol, hydroxypropyl cellulose, and polyolefin.

4. The separator for a secondary battery according to claim 1, wherein the polymer is polyvinylidene fluoride or polyvinylidene fluoride-co-hexafluoropropylene.

5. The separator for a secondary battery according to claim 1, wherein the porous sheet includes 2 to 90 parts by weight of boron nitride nanotubes based on 100 parts by weight of polymer.

6. The separator for a secondary battery according to claim 1, wherein the boron nitride nanotubes have an average external diameter in the range of 10 nm to 100 nm, an average length of 1 μm to 50 μm, and an aspect ratio in the range of 10 to 5000.

7. The separator for a secondary battery according to claim 1, wherein the boron nitride nanotubes have a bulk density in the range of 2.0 g/cm³ to 2.2 g/cm³.

8. The separator for a secondary battery according to claim 1, wherein the separator for a secondary battery has a thermal shrinkage in the range of 0 to 10% after thermal treatment at 170° C. for 30 minutes and a thermal shrinkage in the range of 0 to 20% after thermal treatment at 200° C. for 30 minutes.

9. The separator for a secondary battery according to claim 1, wherein the separator for a secondary battery has a density in the range of 0.3 g/cm³ to 0.7 g/cm³.

10. A separator for a secondary battery which is formed of a single layer of porous sheet,
wherein the porous sheet is a non-woven fiber web, and the non-woven fiber web includes a polymer fiber and boron nitride nanotubes which are embedded in the fiber.

11. The separator for a secondary battery according to claim 10, wherein the boron nitride nanotubes are embedded in the fiber along a fiber length direction.

12. The separator for a secondary battery according to claim 10, wherein the polymer is selected from the group including polyvinylidene fluoride (PVdF), polyvinylidene fluoride-co-hexafluoropropylene (PVdF-HFP), polyvinylidene fluoride-co-trichloroethylene, polymethylmethacrylate, polyacrylonitrile, polyvinylpyrrolidone, polyvinylacetate, polyethylene-co-vinyl acetate, cellulose acetate, cellulose acetate butyrate, cellulose acetate propionate, cyanoethylpullulan, cyanoethylpolyvinylalcohol, cyanoethylcellulose, cyanoethylsucrose, pullulan, carboxyl methyl cellulose, acrylonitrile-styrenebutadiene copolymer, polyimide, styrene butadiene rubber (SBR), carboxymethylcellulose, polyethylene oxide, polyepichlorohydrin, polyphosphazene, polyvinylpyridine, chlorosulfonated polyethylene, latex, polyester resin, acrylic resin, epoxy resin, polyvinyl alcohol, hydroxypropyl cellulose, and polyolefin.

13. The separator fora secondary battery according to claim 10, wherein the polymer is polyvinylidene fluoride or polyvinylidene fluoride-co-hexafluoropropylene.

14. The separator for a secondary battery according to claim 10, wherein the porous sheet includes 2 to 90 parts by weight of boron nitride nanotubes based on 100 parts by weight of polymer.

15. The separator for a secondary battery according to claim 10, wherein the boron nitride nanotubes have an average external diameter in the range of 10 nm to 100 nm, an average length of 1 μm to 50 μm, and an aspect ratio in the range of 10 to 5000.

16. The separator fora secondary battery according to claim 10, wherein the boron nitride nanotubes have a bulk density in the range of 2.0 g/cm³ to 2.2 g/cm³.

17. The separator for a secondary battery according to claim 10, wherein the separator for a secondary battery has a thermal shrinkage in the range of 0 to 10% after thermal treatment at 170° C. for 30 minutes and a thermal shrinkage in the range of 0 to 20% after thermal treatment at 200° C. for 30 minutes.

18. The separator for a secondary battery according to claim 10, wherein the separator for a secondary battery has a density in the range of 0.3 g/cm³ to 0.7 g/cm³.

19. A secondary battery, comprising:
an anode, a cathode, and a separator interposed between the anode and the cathode,
wherein the separator is the separator according to any one of claims 1 to 18.

20. A method for manufacturing a separator for a secondary battery which is formed of a single layer of porous sheet, wherein the porous sheet includes a polymer matrix and boron nitride nanotubes which are embedded in the matrix, comprising steps of:
preparing boron nitride nanotubes and a solvent by dispersing boron nitride nanotubes in the solvent to make a boron nitride nanotube dispersion;
adding polymer in the boron nitride nanotube dispersion; and
preparing a porous sheet by casting or electro spinning the boron nanotube dispersion.
